(19) United States
(12) Patent Application Publication
(10) Pub. No.: US 2021/0299954 A1
(43) Pub. Date: Sep. 30, 2021

(54) 3D PRINTER AND DUAL NOZZLE GUIDING MODULE THEREOF

(71) Applicant: INFINITY 3D PRINTER CO., LTD., KAOHSIUNG CITY (TW)

(72) Inventor: Chung-Yi Liao, Kaohsiung City (TW)

(21) Appl. No.: 17/209,627

(22) Filed: Mar. 23, 2021

(30) Foreign Application Priority Data
Mar. 25, 2020 (TW) 109203411

(51) Int. Cl. B29C 64/209; B29C 64/118; B33Y 30/00; B29C 64/245; B29C 64/232

(52) U.S. Cl. CPC B29C 64/209; B29C 64/118; B29C 64/232; B29C 64/245; B33Y 30/00

(57) ABSTRACT

A 3D printer and a dual nozzle guiding module thereof are disclosed. The dual nozzle guiding module includes a guiding rail, a guiding block slidably coupled to the guiding rail and having a positioning part, and two nozzles slidably coupled to the guiding rail and located on both sides of the guiding block respectively. Each of the two nozzles is separably connected to the positioning part of the guiding block through an adsorption part. The 3D printer includes a bracket, a printing platform coupled to a lifting module of the bracket, and a sliding frame coupled to the bracket and located above the printing platform. The sliding frame has at least one slide rail. The dual nozzle guiding module is slidably coupled to the at least one slide rail.

### CROSS REFERENCE TO RELATED APPLICATION

The application claims the benefit of Taiwan application serial No. 109203411, filed on Mar. 25, 2020, and the entire contents of which are incorporated herein by reference.

### BACKGROUND OF THE INVENTION

### 1. Field of the Invention

The present invention generally relates to an image output device and, more particularly, to a 3D printer with simple structure and easy operation and a dual nozzle guiding module thereof.

### 2. Description of the Related Art

3D printing technology is also known as additive manufacturing (AM), which refers to a process of outputting physical materials in a layered manner to form 3D articles based on 3D model images. The current common 3D printers on the market use fused deposition modeling (FDM) technology, which can output molten materials through single nozzle or multiple nozzles, and control the path of the nozzle outputting materials according to a computer. A modeled article can be formed through stacking and solidifying of the materials layer by layer. During the formation, a single nozzle printer can only produce articles of single color or the same material in a single process, otherwise the printing process must be interrupted to replace the yarn. However, the steps of nozzle cleaning, yarn heating and software setting are time-consuming and labor-intensive. Therefore, a 3D printer with two or more nozzles is more suitable for producing complex and high-quality articles. For example, products that require advanced additive technology such as detachable support materials, multi-color printing, material mixing, and electronic circuit printing may be produced.

The working process of the above-mentioned 3D printer with dual nozzle is to control the two sets of nozzles to move to a predetermined position and output materials in turns. A conventional 3D printer with dual nozzle is composed of two sets of guiding devices respectively coupled to the two nozzles. Each of the two sets of guiding devices and the two sets of nozzles can operate independently and move to a predetermined position for output according to the materials carried by each of them. However, the two sets of nozzles are working in the same space, so they cannot work at the same position simultaneously, and collision must be avoided during the process of moving the two sets of nozzles to the predetermined position, which leads to the editing of the moving path and operation sequence of the two sets of nozzles to be complex and prone to errors. Moreover, the use of the two sets of guiding devices causes the printer to increase in components and bulky. Therefore, the conventional 3D printer is difficult for general users to maintain and carry. Another conventional 3D printer with dual nozzle is that two sets of nozzles are arranged side by side in the same set of guiding devices. It only needs to edit a set of paths to move the two sets of nozzles simultaneously, and then alternately drive the two sets of nozzles to work. However, the two sets of nozzles are arranged adjacently, which causes the two sets of nozzles to easily interfere with each other during the printing process and produce defective articles such as material blending and mutual scratching. In addition, the heating process of the molten materials of the two sets of nozzles influences each other to increase the difficulty of temperature controlling of each of the two sets of nozzles, which results in the failure of the materials to be output in an appropriate molten state, reducing the quality of the products.

In light of this, it is necessary to improve the conventional 3D printer and its dual nozzle guiding module to solve the problems mentioned above.

### SUMMARY OF THE INVENTION

In order to solve the above problems, it is an objective of the present invention to provide a 3D printer and a dual nozzle guiding module thereof, which can reduce the structures used for moving the nozzles, achieving the effects of reducing the size of the equipment and simplifying the operation.

It is another objective of the present invention to provide a dual nozzle guiding module, which can prevent two nozzles from interfering with each other and improve the quality of printing.

It is yet another objective of the present invention to provide a dual nozzle guiding module, which can easily and quickly switch the nozzles for printing.

As used herein, the term “a”, “an”, or “one” for describing the number of the elements and members of the present invention is used for convenience, provides the general meaning of the scope of the present invention, and should be interpreted to include one or at least one. Furthermore, unless explicitly indicated otherwise, the concept of a single component also includes the case of plural components.

The dual nozzle guiding module of the present invention includes a guiding rail, a guiding block slidably coupled to the guiding rail and having a positioning part, and two nozzles slidably coupled to the guiding rail and located on both sides of the guiding block, respectively. Each of the two nozzles is separably connected to the positioning part of the guiding block through an adsorption part.

Accordingly, the dual nozzle guiding module of the present invention can be separately coupled to the two nozzles by the guiding block. Thus, only one set of guiding devices is used to alternately switch the two nozzles, and the two sets of nozzles with different materials can be flexibly applied in a single printing process, achieving the effects of simplifying the moving path of the nozzle and lowering the cost of equipment. In addition, the two nozzles are arranged separately during standby and printing operation, so as to avoid the mutual interference such as heat transfer and scratches, achieving the effect of improving the quality and reliability of the printed articles.

In an example, the guiding rail has two fixing parts located at both ends of the guiding rail, respectively, and the two nozzles can be separably fixed at the both ends of the guiding rail through the two fixing parts, respectively. Thus, each of the two fixing parts can restrict the movement of the unused nozzle, achieving the effect of avoiding the interference of the two nozzles during printing.

In an example, each of adsorption parts is an electromagnet and a direction of magnetic line of force of each of the adsorption parts is a connection direction of each of the adsorption parts and the positioning part, with the positioning part being a paramagnetic substance. Thus, a binding force between the adsorption part and the positioning part can be concentrated and adjusted, achieving the effect of selectively connecting any one of the two nozzles and maintaining a bonding strength.

The 3D printer of the present invention has the dual nozzle guiding module, and includes a bracket having a lifting module capable of moving up and down along the bracket, a printing platform coupled to the lifting module, and a sliding frame coupled to the bracket and located above the printing platform, with the sliding frame having at least one slide rail, and the dual nozzle guiding module slidably coupled to the at least one slide rail.

The 3D printer of the present invention has the dual nozzle guiding module, and includes a bracket having a lifting module capable of moving up and down along the bracket; a sliding frame coupled to the lifting module and having at least one slide rail, with the dual nozzle guiding module slidably coupled to the at least one slide rail; and a printing platform coupled to the bracket and located under the sliding frame.

In an example, the printing platform has a forming plate and a heating part, with the forming plate located on a top of the printing platform and the heating part attached to a bottom surface of the forming plate. Thus, the heating part can keep the forming plate warm and reduce the temperature difference, achieving the effect of avoiding warping caused by inconsistent shrinkage of the printed products.

In an example, the dual nozzle guiding module moves on a working plane through the at least one slide rail, and the working plane and the forming plate of the printing platform are parallel to a horizontal plane. Thus, the nozzles can be deposited horizontally on the forming plate layer by layer, achieving the effects of maintaining printing stability and improving the quality of the printed articles.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 shows a perspective view of a 3D printer of a preferred embodiment according to the present invention.

FIG. 2 shows a partial perspective view of a 3D printer of a preferred embodiment according to the present invention.

FIG. 3 shows an assembly front view of a dual nozzle guiding module of a preferred embodiment according to the present invention.

FIG. 4 shows a cross-sectional diagram taken along line 4-4 in

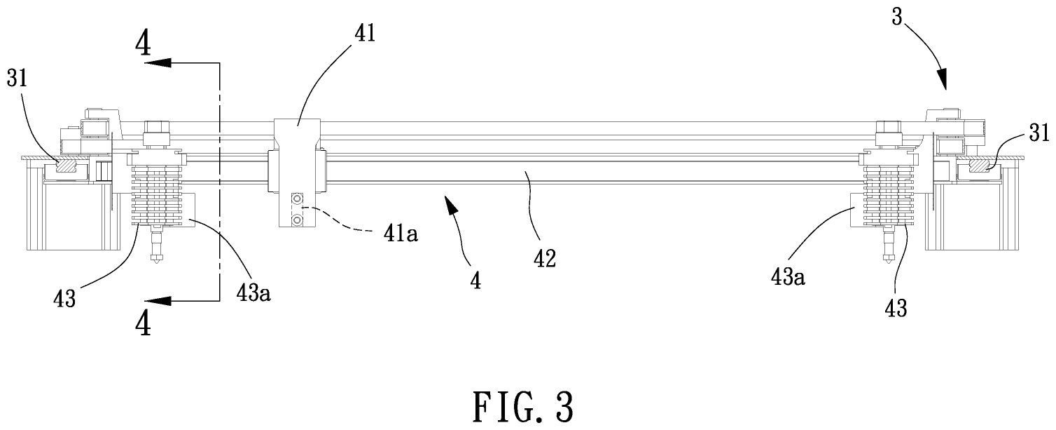

FIG. 3.

FIG. 5 shows a top view of a dual nozzle guiding module of a preferred embodiment according to the present invention.

FIG. 6 shows an action of the dual nozzle guiding module as shown in FIG. 5.

In the various figures of the drawings, the same numerals designate the same or similar parts. Furthermore, when the terms “left”, “right”, “up (top)”, “low (bottom)”, and similar terms are used herein, it should be understood that these terms have reference only to the structure shown in the drawings as it would appear to a person viewing the drawings and are utilized only to facilitate describing the invention, rather than restricting the invention.

### DETAILED DESCRIPTION OF THE INVENTION

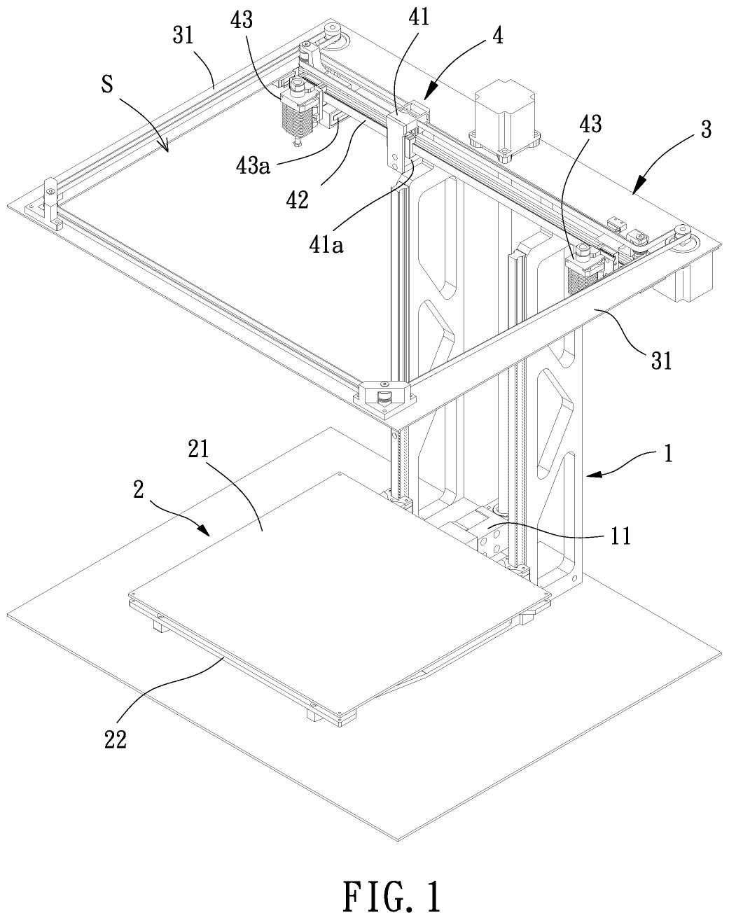

Please refer to FIG. 1, which shows a preferred embodiment of a 3D printer with a dual nozzle guiding module of the present invention. The 3D printer includes a bracket 1, a printing platform 2, a sliding frame 3 and the dual nozzle guiding module 4. The printing platform 2 and the sliding frame 3 are located at both ends of the bracket 1, respectively, and the dual nozzle guiding module 4 is slidably coupled to the sliding frame 3.

The bracket 1 has a lifting module 11, which can move up and down along the bracket 1. A moving direction of the lifting module 11 is preferably perpendicular to a horizontal plane. The lifting module 11 can be used to couple to the printing platform 2 or the sliding frame 3. However, the present invention is not limited in this regard. The printing platform 2 and the sliding frame 3 can move toward or against each other in a vertical direction through the lifting module 11.

The printing platform 2 can be provided with a forming plate 21 and a heating part 22. The forming plate 21 is located on a top of the printing platform 2. The forming plate 21 can be made of glass and preferably kept horizontal, so that a printed article can be stably and gradually stacked on the forming plate 21, and the printed article can be easily removed from the forming plate 21 after the printing is completed. The heating part 22 can be attached to a bottom surface of the forming plate 21, while the heating part 22 keeps the forming plate 21 warm, and minimizes the temperature difference between each parts of the forming plate 21 to the best extent, so as to avoid warping of the finished product caused by inconsistent cooling-shrinkage speed of the thermoplastic printing materials during the stacking process.

The sliding frame 3 has at least one slide rail 31 arranged along a working plane S. The working plane S is preferably parallel to the forming plate 21 of the printing platform 2, and the dual nozzle guiding module 4 can be moved on the working plane S through the slide rail 31. In this embodiment, the sliding frame 3 has two slide rails 31 parallel to each other and located at two opposite sides of the working plane S, respectively. Two ends of the dual nozzle guiding module 4 are slidably connected to the two slide rails 31, respectively, so that the dual nozzle guiding module 4 spans the working plane S. The dual nozzle guiding module 4 can move back and forth along an extension direction of the two slide rails 31, and the dual nozzle guiding module 4 can sweep the entire area of the working plane S during the sliding process.

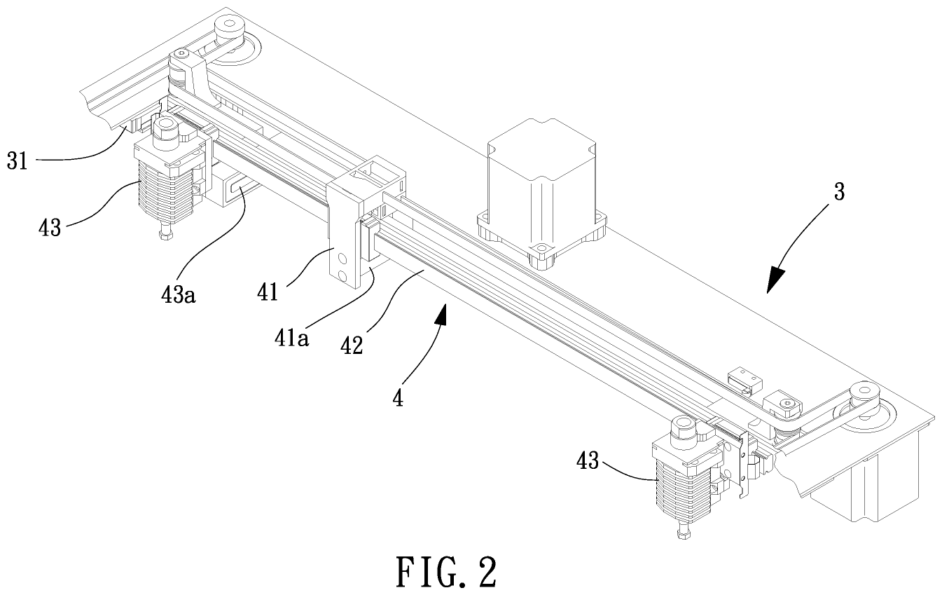

Please refer to FIGS. 1 and 2, the dual nozzle guiding module 4 has a guiding block 41 which can be slidably coupled to a guiding rail 42. The guiding block 41 can move in the extension direction of the guiding rail 42. The guiding rail 42 is arranged along the working plane S and the guiding rail 42 is preferably perpendicular to the slide rail 31, so that the slide rail 31 and the guiding rail 42 can correspond to two coordinate axes of a rectangular coordinate system, respectively. The rectangular coordinate system is used to mark and locate any position on the working plane S. When the guiding block 41 moves along the guiding rail 42 and with the dual nozzle guiding module 4 moving along the slide rail 31, the guiding block 41 moves along the two coordinate axes of the rectangular coordinate system. In this way, the guiding block 41 can be positioned to any point on the working plane S according to the given coordinate values.

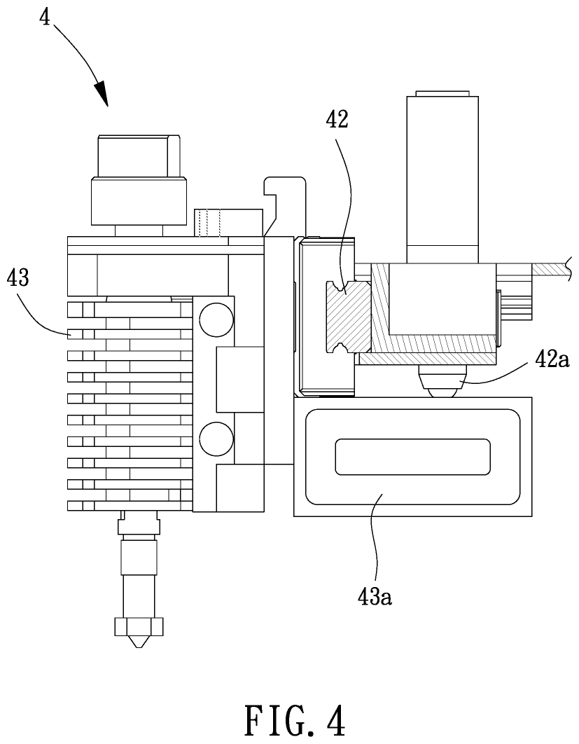

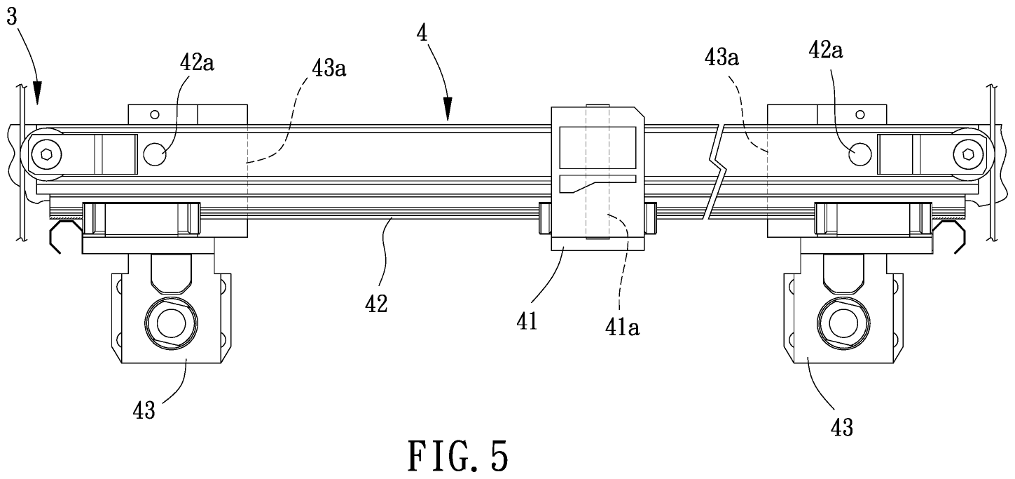

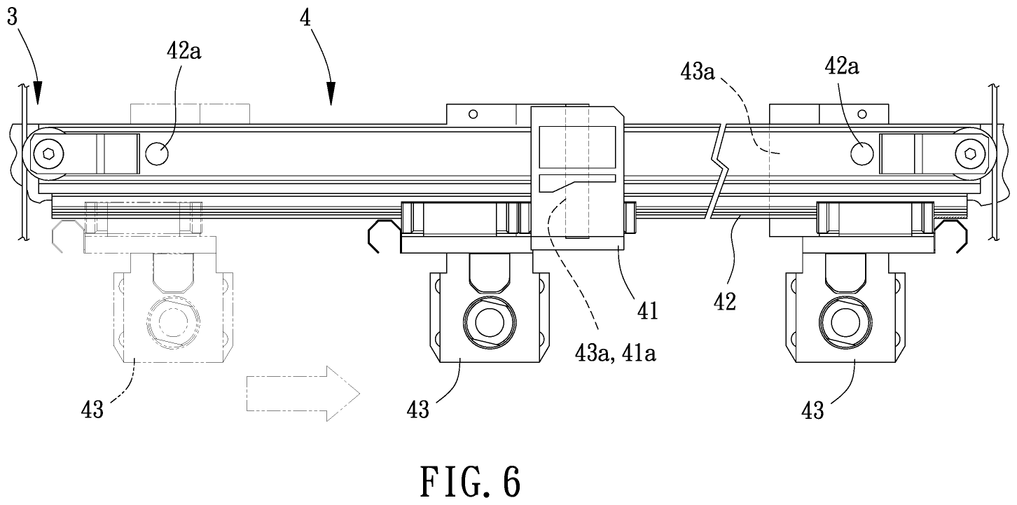

Please refer to FIGS. 3 and 4, the dual nozzle guiding module 4 further has two nozzles 43 which can be slidably coupled to the guiding rail 42, and the two nozzles 43 are located on both sides of the guiding block 41, respectively. The two nozzles 43 can carry printing filaments of different materials, respectively. Each of the two nozzles 43 has an adsorption part 43a, and an adsorption direction of each of the adsorption parts 43a is preferably towards the guiding block 41 and the other nozzle 43. When the guiding block 41 moves along the guiding rail 42 and approaches any one of the nozzles 43, the guiding block 41 can be separably connected to the adsorption part 43a of the nozzle 43 through a positioning part 41a, while the guiding block 41 drives the nozzle 43 to move on the guiding rail 42. In addition, each of the two adsorption parts 43a can be an electromagnet, which can generate an electromagnetic field after energizing each of the two adsorption parts 43a, and a direction of magnetic line of force is the adsorption direction. Furthermore, the positioning part 41a is preferably a paramagnetic substance, so that the larger the external magnetic field located at the positioning part 41a, the greater the magnetic attraction force can be generated. In this way, by controlling the current switch and the size through the two adsorption parts 43a, the guiding block 41 can be selected to connect any one of the two nozzles 43 and to adjust the bonding strength.

Furthermore, the guiding rail 42 can also have two fixing parts 42a which are located at both ends of the guiding rail 42, respectively. When the two nozzles 43 are not connected to the guiding block 41, the two fixing parts 42a restrict the two nozzles 43 to stay at the both ends of the guiding rail 42, respectively. Each of the two fixing parts 42a preferably fixes each of the two nozzles 43 by frictional force, and the frictional force between each of the two nozzles 43 and each of the two fixing parts 42a is less than the magnetic attraction force between the positioning part 41a and each of the two adsorption parts 43a. In this way, each of the two nozzles 43 after being energized can offset the frictional force with each of the two fixing parts 42a through magnetic attraction force, so that each of the two nozzles 43 can move with the guiding block 41, while the unused nozzle 43 can be restricted by the fixing part 42a. Thus, the effect of preventing the two nozzles 43 from sliding on the guiding rail 42 at the same time and interfering with the printing process can be achieved. In this embodiment, each of the two fixing parts 42a is a domed cap nut located at the bottom of the guiding rail 42 with the dome abuts against the top of the adsorption part 43a, so as to generate frictional force opposite to a sliding direction between the fixing part 42a and the adsorption part 43a, while the frictional force offsets any force that pulls or pushes each of the two nozzles 43 to move. However, the structure of the fixing part 42a of the present invention is not limited in this regard.

Please refer to FIGS. 5 and 6, the 3D printer of the present invention can have a control module (not shown) which can plan the printing process and send instruction. The guiding block 41 of the dual nozzle guiding module 4 can slide to a predetermined position on the guiding rail 42 according to the instruction. When the guiding block 41 is close to one of the two nozzles 43, the one of the two nozzle 43 activates the adsorption part 43a to connect to the positioning part 41a of the guiding block 41 according to the instruction, and then the control module continuously operates the guiding block 41 and the nozzle 43 to the predetermined position to work through the instruction. In addition, when the printing filament needs to be replaced for operation, the guiding block 41 returns to the initial position of the nozzle 43 according to the instruction, and makes the adsorption part 43a separate from the positioning part 41a. Then, the control module operates the guiding block 41 to move to the other nozzle 43 through a new instruction, while the nozzle 43 activates the adsorption part 43a to connect to the positioning part 41a. In this way, the dual nozzle guiding module 4 controls the nozzle 43 connected to the positioning part 41a to move to a predetermined printing position by taking the position of the positioning part 41a as a reference point. The guiding block 41 can be alternately connected and used the two nozzles 43 for printing operation. By mixing and matching the printing filaments of different materials carried by the two nozzles 43, various applications of 3D printing can be performed.

In summary, the 3D printer and the dual nozzle guiding module thereof according to the present invention can be separably coupled to the two nozzles by the guiding block. Therefore, only one set of the guiding devices is used to alternately switch the two nozzles, and the two sets of nozzles with different materials can be applied flexibly in a single printing process, thereby achieving the effects of simplifying the moving path of the nozzle, lowering the cost of equipment and reducing the volume of the printer. In addition, the two nozzles are arranged separately during standby and printing operation, so as to avoid the mutual interference such as heat transfer and scratches, thereby achieving the effect of improving the quality and reliability of the printed articles.

Although the invention has been described in detail with reference to its presently preferable embodiments, it will be understood by one of ordinary skill in the art that various modifications can be made without departing from the spirit and the scope of the invention, as set forth in the appended claims.

What is claimed is:

1. A dual nozzle guiding module, comprising:
a guiding rail;
a guiding block slidably coupled to the guiding rail and having a positioning part; and
two nozzles slidably coupled to the guiding rail and located on both sides of the guiding block, respectively, with each of the two nozzles separably connected to the positioning part of the guiding block through an adsorption part.

2. The dual nozzle guiding module as claimed in claim 1, wherein the guiding rail has two fixing parts located at both ends of the guiding rail, respectively, and the two nozzles are separably fixed at the both ends of the guiding rail through the two fixing parts, respectively.

3. The dual nozzle guiding module as claimed in claim 1, wherein each of adsorption parts is an electromagnet, and a direction of magnetic line of force of each of the adsorption parts is a connection direction of each of the adsorption parts and the positioning part, with the positioning part being a paramagnetic substance.

4. A 3D printer having the dual nozzle guiding module as claimed in claim 1, comprising:
a bracket having a lifting module capable of moving up and down along the bracket;
a printing platform coupled to the lifting module; and
a sliding frame coupled to the bracket and located above the printing platform, with the sliding frame having at least one slide rail and the dual nozzle guiding module slidably coupled to the at least one slide rail.

5. The 3D printer as claimed in claim 4, wherein the printing platform has a forming plate and a heating part, with the forming plate located on a top of the printing platform and the heating part attached to a bottom surface of the forming plate.

6. The 3D printer as claimed in claim 5, wherein the dual nozzle guiding module moves on a working plane through the at least one slide rail, and the working plane is parallel to the forming plate of the printing platform.

7. A 3D printer having the dual nozzle guiding module as claimed in claim 1, comprising:
a bracket having a lifting module capable of moving up and down along the bracket;
a sliding frame coupled to the lifting module and having at least one slide rail, and the dual nozzle guiding module slidably coupled to the at least one slide rail; and
a printing platform coupled to the bracket and located under the sliding frame.

8. The 3D printer as claimed in claim 7, wherein the printing platform has a forming plate and a heating part, with the forming plate located on a top of the printing platform and the heating part attached to a bottom surface of the forming plate.

9. The 3D printer as claimed in claim 8, wherein the dual nozzle guiding module moves on a working plane through the at least one slide rail, and the working plane and the forming plate of the printing platform are parallel to a horizontal plane.
